(19) United States
(12) Patent Application Publication
(10) Pub. No.: US 2008/0049334 A1
(43) Pub. Date: Feb. 28, 2008

(54) Zoom lens optical system and digital photographing device having same

(75) Inventors: Jeong-Kil Shin, Suwon-si (KR); Byung-Kwon Kang, Suwon-si (KR); Sung-Woo Kim, Uiwang-si (KR); Yong-Nam Kim, Uiwang-si (KR)

Correspondence Address: CHA & REITER, LLC, 210 ROUTE 4 EAST STE 103, PARAMUS, NJ, 07652, US

(73) Assignees: Samsung Electronics Co., LTD; Power Optics Co., LTD

(21) Appl. No.: 11/890,244

(22) Filed: Aug. 3, 2007

(30) Foreign Application Priority Data
Aug. 24, 2006 (KR) 2006-80359

(51) Int. Cl. G02B 15/14

(52) U.S. Cl. 359/687

(57) ABSTRACT

Disclosed is a zoom lens optical system. The optical system includes a first lens group, which is fixed and has a total reflection prism, the prism turning an optical axis from an object side to an image side, and the first lens group having a positive lens power, a second lens group having a negative lens power, a third lens group having a positive lens power; and a fourth lens group having a positive lens power. The first through fourth lens groups are sequentially arranged from the object side to the image side, and the fourth lens group is fixed while magnification variation is executed by moving the second lens group and the third lens group.

### CLAIM OF PRIORITY

This application claims the benefit of the earlier filing date, pursuant to 35 USC 119, to that patent application entitled “Zoom Lens Optical System and Digital Photographing Device Having the Same,” filed in the Korean Intellectual Property Office on Aug. 24, 2006 and assigned Serial No. 2006-80359, the contents of which are hereby incorporated by reference.

### BACKGROUND OF THE INVENTION

1. Field of the Invention

The present invention relates to an optical systems, and more particularly to a miniaturized zoom lens for use in a portable phone camera or a miniaturized digital photographing camera.

2. Description of the Related Art

A digital optical lens system employing an image sensor, such as a CMOS (Complementary Metal-Oxide Semiconductor), a CCD (Charge-Coupled Device), etc., converts inputted light into an electric signal through a photographing device. Therefore, such a digital lens system employing a bright lens with a large aperture is used as a photographing lens, and an optical filter is inserted between the lens and the image sensor.

For this reason, it is necessary for a conventional image sensor image formation optical system to have a back focal length which is long as compared to an effective focal length, and such a conventional sensor image formation optical system should be a telecentric optical system in which a chief ray of light beam is perpendicularly incident into the image sensor.

In particular, a zoom lens optical system of a miniaturized digital photographing device is configured in such a way that an optical axis is turned by a prism. As a result, the optical total lengths should be equal to each other at a wide angle position or a wide angle end and a telephoto position or a telephoto end.

The prior art related to a zoom lens optical system employing a above-mentioned image sensor is disclosed in U.S. Pat. Nos. 6,771,432B2, and 6,975,462B2, and U.S. Unexamined Patent Publications, US2006/0056052A1 and US2006/0066956A1.

Among the above-mentioned prior art, each of the zoom lenses disclosed in U.S. Pat. No. 6,771,432B2 and U.S. Pat. No. 6,975,462B2 consists of a fixed first lens group having positive refracting power from an object side, a second lens group having negative refracting power and moving when the magnification of the zoom lens is varied, a third lens group having positive refracting power and moving when the magnification is varied, and a fourth lens group having positive refracting power and moving when the magnification is varied, wherein the magnification is varied while the second lens group and the third lens group approach each other, and auto-focusing (AF) is executed by using the fourth lens group. This arrangement is advantageous in that the difference in F number is small between the wide angle end and the telephoto end, and the difference in chief ray angle (CRA) according to the height of a surface of image incident into the sensor surface is small between the wide angle end and the telephoto end. However, such an arrangement has a disadvantage in that the production ability thereof is poor because the optical system is long and very sensitive to component tolerance and assembling tolerance.

The zoom lens disclosed in US2006/0056052A1 consists of a first lens group having positive refracting power from an object side, a second lens group having negative refracting power, a third lens group having positive refracting power, and a fourth lens group having positive refracting power, wherein the magnification of the zoom lens is varied by moving the second and fourth lens groups, and auto-focusing is executed by moving the fourth lens group. Because the third lens group is fixed, such an arrangement has a disadvantage in that the optical total length is long and the manufacturing sensitivity is high.

The conventional zoom lens disclosed in US2006/0066956A1 consists of a first lens group having negative refracting power from an object side, a second lens group having positive refracting power, a third lens group having positive refracting power, and a fourth lens group having positive refracting power. Magnification is varied by moving the second and third lens groups, and auto-focusing is executed by using the fourth lens group. This arrangement has a compromised configuration making up the disadvantages of the above-mentioned prior arts. However, because the number of lenses is increased, the manufacturing costs are high and there is limitation in reducing the optical total length.

### SUMMARY OF THE INVENTION

The present invention provides a zoom lens optical system that can satisfy both stable design performance and mass production ability, and which can be easily miniaturized, and a digital photographing device having such a zoom lens optical system.

In accordance with an aspect of the present invention, there is provided a zoom lens optical system including a first lens group, which is always fixed and has a total reflection prism, the prism turning an optical axis from an object side to an image side, and the first lens group having a positive lens power, a second lens group having a negative lens power; a third lens group having a positive lens power and a fourth lens group having a positive lens power, wherein the first through fourth lens groups are sequentially arranged from the object side to the image side, and the fourth lens group is fixed while magnification variation is executed by moving the second lens group and the third lens group.

In accordance with the second aspect of the present invention, there is also provided a digital photographing device including: the above-mentioned zoom lens optical system, a driving unit for the movable lens groups of the zoom lens optical system, an image processing unit for processing a signal inputted from the zoom lens optical system and outputting a digital image, a manipulation unit used by a user to generate a photographing command signal and a control unit for controlling the driving unit according to the photographing command signal so that photographing is executed at a predetermined magnification.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view illustrating a zoom lens optical system according to a first embodiment of the present invention;

FIG. 2 is view illustrating a zoom lens optical system according to a second embodiment of the present invention;

FIGS. 3A and 3B are aberration graphs at a wide angle end (W) and a telephoto end of the zoom lens optical system of FIG. 1, to which the data indicated in Tables 1 through 3 are applied;

FIGS. 4A and 4B are aberration graphs at a wide angle end (W) and a telephoto end of the zoom lens optical system of FIG. 2, to which the data indicated in Tables 4 through 6 are applied;

FIG. 5 is a block diagram illustrating a construction of an embodiment of a digital photographing device equipped with the zoom lens optical system in accordance with the principles of the invention; and

FIG. 6A is a view illustrating an example of a digital photographing device, within which the inventive zoom lens optical system is contained;

FIG. 6B is a view illustrating a construction applicable to the back side of the digital photographing device of FIG. 6a by way of an example; and

FIG. 7 is a view illustrating how to mount the inventive zoom lens optical system within a digital photographing device by way of an example.

### DETAILED DESCRIPTION OF THE INVENTION

Exemplary embodiments of the present invention will be described with reference to the accompanying drawings. For the purposes of clarity and simplicity, a detailed description of known functions and configurations incorporated herein will be omitted as it may make the subject matter of the present invention unclear.

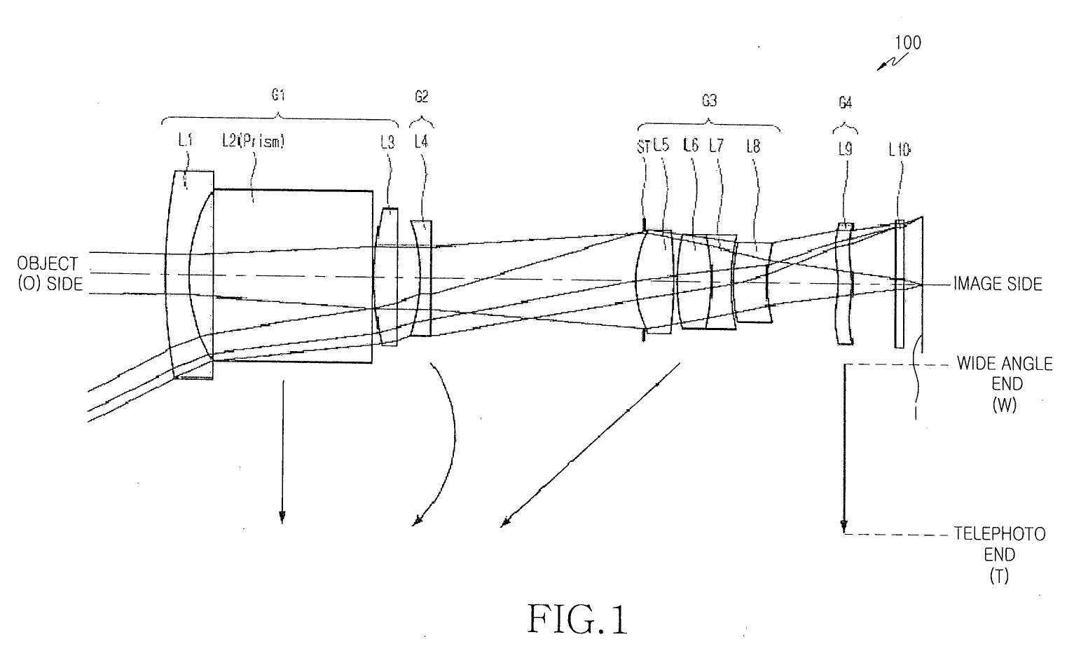

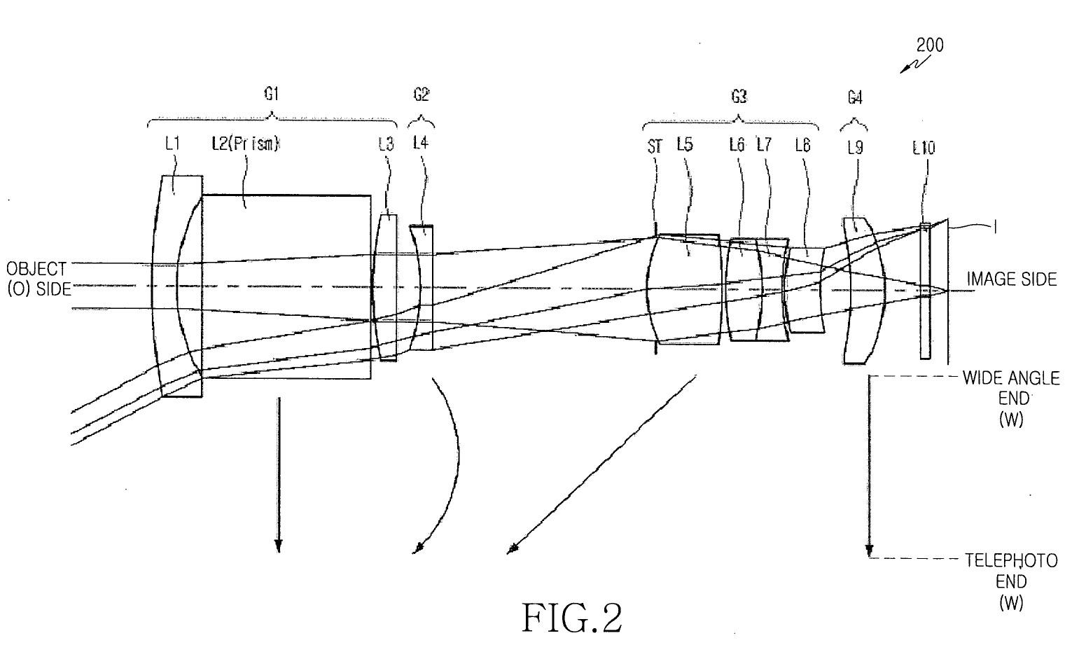

FIGS. 1 and 2 illustrate zoom lens optical system according to first and second embodiments of the present invention, respectively.

Referring to FIGS. 1 and 2, the inventive zoom lens optical system includes a first lens group G1 through a fourth lens group G4, which are sequentially arranged from an object O side to an image side, and an image sensor I. The first lens group G1 is always fixed and has a total reflection right-angle prism L2 which turns an optical axis 90 degrees, wherein the first lens group G1 has a negative refracting power. The second lens group G2 has a negative refracting power, the third lens group G3 has a positive refracting power, and the fourth lens group G4 has positive refracting power. In addition, while zooming is accomplished through the movement of the second lens group G2 and the third lens group G3, the fourth lens group G4 is fixed. In the drawings, L10 denotes an optical filter such as an Infrared (IR) cut-filter having an IR filtering function.

Here, the first lens group G1 is always fixed, wherein the first lens group G1 may be configured only by the prism L2 or a first lens L1 and the prism L2.

Referring to FIGS. 1 and 2, in order to reduce the size of the prism, the first lens group G1 may be configured by the first lens L1 having a negative refracting power, the total reflection right-angle prism L2, and a third lens L3, the sides of which are aspherical, for correcting aberrations at a wide angle end and a telephoto end and for reducing the difference in F number between the wide angle end and the telephoto angle end.

In order to reduce the difference in F number between the wide angle end and the telephoto end while miniaturizing the zoom lens optical system, it is desirable that the focal length f_{G1} of the first lens group and the focal length f_{W} at the wide angle end satisfy Formula 1.

$$- 25.0 > \frac{{f}_{G 1}}{{f}_{W}} > - 40.0 \qquad ( 1 )$$

In Formula 1, as the focal length of the first lens group G1 is increased in a positive (+) direction, the incident height for the prism is increased, whereby the size of the prism is increased. On the other hand, as the focal length of the first lens group G1 is altered in negative (−) direction, the size of the entrance pupil of the telephoto end is reduced, whereby the difference in F number between the telephoto end and the wide angle end is increased.

At this time, as a requirement for reducing the size of the prism L2 included in the first lens group G1, it is desirable that the focal length f_{L1} of the first lens and the focal length f_{W} at the wide angle end satisfy Formula 2.

$$- 2.0 > \frac{{f}_{L 1}}{{f}_{W}} > - 3.0 \qquad ( 2 )$$

Herein, if the conditional value of Formula 2 becomes not less than the upper limit 2.0, the size of the prism is increased because the incident height for the prism from the first lens L1 is increased. In addition, if the conditional value of Numerical Expression 2 becomes not more than the lower limit −3.0, a difference in position and size between the entrance pupils of the wide angle end and the telephoto end occurs. As a result the difference in F number is increased.

In addition, the relationship between the focal length f_{G1} of the first lens group and the focal length f_{L3} of the third lens included in the first lens group satisfies Formula 3.

$$- 7.0 > \frac{{f}_{G 1}}{{f}_{L 3}} > - 12.0 \qquad ( 3 )$$

Formula 3 indicates that when the first lens group G1 consists of three lenses, i.e., first through third lenses, the first lens group is configured in such a way that the first lens group entirely has a negative refracting power and the third lens L3 has a positive refracting power so as to miniaturize the optical system. On the basis of this condition, it is possible to reduce the difference in F number between the wide angle end and the telephoto end. As the conditional value of Formula 3 is increased, the difference in F number between the wide angle end and the telephoto end is increased. As such, if the conditional value of Formula 3 becomes not more than the upper limit −7.0, the difference in F number between the wide angle end and the telephoto end is increased. As the conditional value of Formula 3 is decreased, the size of the optical system is increased. As such, if the conditional value of Formula 3 becomes not more than the lower limit −12.0, the size of the optical system is increased.

The second lens group G2 having a negative refracting power is configured by one lens, i.e., the fourth lens L4, thereby enabling miniaturization and reduction of price. The second lens group G2 moves together with the third lens group G3, thereby serving to make optical total lengths be equal to each other in all zooming positions.

At this time, the focal length f_{G2} of the second lens group G2 is optimized when it satisfies Formula 4 in relation to the focal length f_{W}.

$$- 2.0 > \frac{{f}_{G 2}}{{f}_{W}} > - 3.0 \qquad ( 4 )$$

Formula 4 is a condition for allowing the second lens group G2 to correct aberrations with one lens, and in a condition out of this range, the aberrations can be corrected by using two lenses.

It is desirable to configure the second lens group G2 with one lens, i.e., the fourth lens L4 in a condition satisfying Formula 4, and in order to assure aberration correction for the wide angle end W and the telephoto end T to be optimized, it is desirable that the relationship of the curvature radii R1_{L4} and R2_{L4} of first and second surfaces of the fourth lens L4 satisfies Formula 5.

$$- 5.0 > \frac{R {2}_{L 4}}{R {1}_{L 4}} > - 20.0 \qquad ( 5 )$$

Formula 5 is a condition for optimizing the curvature configuration of a lens, wherein at the wide angle end W, the entire surface of the lens is used, and at the telephoto end T, the center portion of the lens is used.

The third lens group G3 having a negative refracting power includes a fixed stop ST and is configured in such a manner that the difference in F number between the wide angle end W and the telephoto end T is not so large even when the optical system zooms between these positions, wherein the third lens group G3 further includes two aspherical lenses L5 and L8, and one cemented lens L6/L7 for correcting a chromatic aberration.

As the optical system zooms from the wide angle end W to the telephoto end, the third lens group G3 linearly moves from the image side to the object O side, and at the same time, the second lens group G2 performs curvilinear movement. That is, the third lens group G3 moves continuously toward the object O side, and the second lens group G2 moves toward the image side and then moves toward the object O side.

In order to reduce the difference in F number between the wide angle end W and the telephoto end T, it is desirable that the amount of unit movement X_{G3} and the magnification M_{G3} of the third lens group G3 satisfy Formula 6.

$$- 0.08 > \frac{{M}_{G 3}}{{X}_{G 3}} > - 0.13 \qquad ( 6 )$$

Formula 6 indicates a condition for optimizing the magnification of the third lens group G3 so as to minimize the moving distance of the third lens group G3, and so to miniaturize the optical system. If the conditional value of Formula 6 is decreased, the magnification is increased and the amount of movement is reduced but the manufacturing yield is degraded because the manufacturing sensitivity is increased. On the other hand, if the conditional value of Formula 6 is increased, the size of the optical system is increased because the amount of movement is increased although the manufacturing sensitivity is reduced.

In addition, as a condition for suppressing the occurrence of a ghost image while reducing the difference in chief ray angles according to the incident heights at the image sensor I at the wide angle end W and the telephoto end T, it is desirable that the amount of unit movement X_{G3} of the third lens group G3, the focal length f_{W} at the wide angle end, and the focal length f_{T} at the telephoto end T satisfy Formula 7.

$$0.60 > \frac{{f}_{T}}{{f}_{W} {X}_{G 3}} > 0.45 \qquad ( 7 )$$

It is desirable that the sensitivity of the fifth lens L5 having a large refracting power is distributed to the eighth lens L8 so as to increase the yield in a manufacturing process, and among the opposite surfaces S16 and S17 of the eighth lens L8, the object side surface S16 is aspherically formed and the image side surface S17 is spherically formed so as to reduce the manufacturing sensitivity. The eighth lens L8 configured in this manner serves to reduce the difference in chief ray angles according to incident heights at the image sensor at the wide angle end W and the telephoto end T.

Formula 7 indicates a condition for minimizing chief ray angles according to the incident heights at the wide angle end and the telephoto end. If the conditional value of Formula 7 is decreased, the size of the optical system is increased although the difference in chief ray angles between the wide angle end and the telephoto end is decreased, if the conditional value is increased, the size of the optical system is decreased although the difference in chief ray angles between the wide angle end and the telephoto end is increased. Formula 7 indicates an optical condition for minimizing chief ray angles in consideration of the size of the optical system.

The fourth lens group G4 is preferably configured by one aspherical lens L9 that can be formed from a plastic material. The fourth lens group G4 serves to control the rate of marginal illumination as compared to central illumination at the telephoto end, and chief ray angles according to incident heights at the image sensor, wherein the fourth lens group G4 is fixed at the time of magnification variation.

The optical paths at the wide angle end W pass the center of the fourth lens group G4, and the optical paths at the telephoto end T pass the entire surface of the fourth lens G4. At this time, it is possible to control the rate of marginal illumination as compared to central illumination at the wide angle end W by properly adjusting the effective diameter of the ninth lens L9. If the size of the ninth lens L9 of the fourth lens group G4 is increased, the diameter of the lens group G4 is increased although the marginal illumination rate is increased, and if the size of the lens L9 is reduced, the marginal illumination rate is reduced. The lens capable of controlling chief ray angles according to incident heights at the image sensor is a lens most nearly arranged in relation to the image sensor, wherein the lens L9 of the fourth group G4 performs such fine adjustment of chief ray angles.

Here, automatic focal adjustment for correcting the movement of focal position according to magnification variation can be performed by moving the lens L9 of the fourth lens group.

In addition, the automatic focal adjustment according to magnification variation can be also performed by moving the image sensor I.

Table 1 below shows data for respective lenses of the zoom lens optical system having a configuration of the embodiment of FIG. 1.

TABLE 1

| | | | Radius of | | | Abbe's |
|---|---|---|---|---|---|---|
| | | Surface | curvature | Thickness | Refractive | Number |
| Group | Lens | No. | (R, mm) | (D, mm) | index (Nd) | (Vd) |
| | | 0 | Infinity | Infinity | | |
| G1 | L1 | S1 | 18.025 | 0.900 | 1.80610 | 33.27 |
| | | S2 | 5.640 | 0.950 | | |
| | L2 | S3 | Infinity | 2.750 | 1.62299 | 58.12 |
| | (Prism) | S4 | Infinity | 2.750 | | |
| | | S5 | Infinity | 0.140 | | |
| | L3 | *S6 | 11.421 | 0.800 | 1.63200 | 23.41 |
| | | *S7 | −83.617 | *0.717 | | |
| G2 | L4 | S8 | −7.653 | 0.500 | 1.71300 | 53.93 |
| | | S9 | −59.133 | *7.082 | | |
| G3 | | STOP | Infinity | 0.000 | | |
| | L5 | *S11 | 3.380 | 1.380 | 1.59201 | 67.05 |
| | | *S12 | −13.235 | 0.200 | | |
| | L6/L7 | S13 | 7.970 | 1.140 | 1.72916 | 54.67 |
| | | S14 | −7.970 | 0.670 | 1.90366 | 31.31 |
| | | S15 | 5.000 | 0.170 | | |
| | L8 | *S16 | 5.170 | 1.000 | 1.53113 | 55.73 |
| | | S17 | 3.153 | *2.521 | | |
| G4 | L9 | *S18 | −9.853 | 0.630 | 1.53113 | 55.73 |
| | | *S19 | −6.008 | 1.400 | | |
| Filter | L10 | S20 | Infinity | 0.300 | 1.51680 | 64.19 |
| | | S21 | Infinity | 0.601 | | |
| | | I | Infinity | −0.001 | | |

In Table 1, some asterisked Surface Nos. indicates that corresponding lens surfaces are asymmetrical, which satisfy Formula 8 in relation to aspherical constants presented in Table 2 below.

TABLE 2

| Surface No. | *S6 | *S7 | *S11 | *S12 | *S16 | *S18 | *S19 |
|---|---|---|---|---|---|---|---|
| K | 1.077150E+00 | 1.227782E+02 | −1.076611E+00 | −3.000000E+00 | −6.069870E+00 | 4.272143E+00 | 3.086019E+00 |
| A | 1.109910E−03 | 8.364600E−04 | 1.806250E−03 | 9.700000E−05 | −6.947930E−03 | 1.555780E−02 | 1.834390E−02 |
| B | −1.092980E−04 | −1.210300E−04 | −6.118820E−06 | 4.021380E−05 | −1.082110E−03 | 2.416800E−03 | 1.444110E−03 |
| C | 5.997660E−06 | 8.139420E−06 | 2.000200E−05 | 0.000000E+00 | −5.136910E−04 | −7.258040E−04 | 1.005380E−04 |
| D | 3.365540E−06 | 4.128390E−06 | −1.536590E−06 | 0.000000E+00 | 8.471500E−05 | 8.826380E−05 | −1.178710E−04 |
| E | 0.000000E+00 | 0.000000E+00 | 0.000000E+00 | 0.000000E+00 | 0.000000E+00 | −2.079740E−06 | 1.705240E−05 |

$$x = \frac{{c}^{2} {y}^{2}}{1 + \sqrt{1 - ( K + 1 ) {c}^{2} {y}^{2}}} + {Ay}^{4} + {By}^{6} + {Cy}^{8} + {Dy}^{10} + {Ey}^{12} \qquad ( 8 )$$

Here, x indicates a distance in the optical axial direction from the apex of a lens, y indicates a distance in the direction perpendicular to the optical axis from the apex of a lens, c indicates the reciprocal number (1/R) of a radius of curvature at the apex of a lens, K indicates a conic constant, and A, B, C, D and E indicate aspherical constants (Table 2).

Table 3 below presents distances for respective zoom positions of the asterisked parts among the items of Thickness (D) in Table 1.

TABLE 3

| Surface | Wide Angle End | | Telephoto End |
|---|---|---|---|
| No. | (W) | Middle End | (T) |
| 7 | 0.717 | 2.711 | 1.600 |
| 9 | 7.082 | 2.881 | 0.460 |
| 17 | 2.521 | 4.728 | 8.260 |

In addition, Table 4 below presents an example of data of respective lenses of the zoom lens optical system having the construction of the embodiment of FIG. 2.

TABLE 4

| | | | Radius of | | | Abbe's |
|---|---|---|---|---|---|---|
| | | Surface | curvature | Thickness | Refractive | Number |
| Group | Lens | No. | (R, mm) | (D, mm) | index (Nd) | (Vd) |
| | | OBJ | Infinity | Infinity | | |
| G1 | L1 | S1 | 46.971 | 0.625 | 1.79500 | 45.40 |
| | | S2 | 7.549 | 0.800 | | |
| | L2 | S3 | Infinity | 2.950 | 1.88300 | 40.80 |
| | (Prism) | S4 | Infinity | 2.950 | | |
| | | S5 | Infinity | 0.232 | | |
| | L3 | *S6 | 10.857 | 1.000 | 1.76655 | 48.81 |
| | | *S7 | 5645.973 | *0.696 | | |
| G2 | L4 | S8 | −7.888 | 0.500 | 1.70308 | 55.34 |
| | | S9 | 140.104 | *6.152 | | |
| G3 | | STOP | Infinity | 0.100 | | |
| | L5 | *S11 | 2.966 | 2.066 | 1.61051 | 58.58 |
| | | *S12 | −13.215 | 0.325 | | |
| | L6/L7 | S13 | 5.502 | 1.122 | 1.71620 | 49.52 |
| | | S14 | −5.502 | 0.510 | 1.90400 | 31.30 |
| | | S15 | 2.677 | 0.139 | | |
| | L8 | S16 | 3.177 | 0.760 | 1.67800 | 55.50 |
| | | S17 | 2.613 | *0.894 | | |
| G4 | L9 | *S18 | −5.539 | 1.121 | 1.53113 | 55.73 |
| | | *S19 | −3.105 | 1.400 | | |
| Filter | L10 | S20 | Infinity | 0.300 | 1.51680 | 64.19 |
| | | S21 | Infinity | 0.498 | | |
| | | I | Infinity | 0.002 | | |

In Table 4, some asterisked Surface Nos. indicates that corresponding lens surfaces are asymmetrical, which satisfy Formula 8 above in relation to aspherical constants presented in Table 5 below.

TABLE 5

| Surface No. | *S6 | *S7 | *S11 | *S12 | *S18 | *S19 |
|---|---|---|---|---|---|---|
| K | 1.12637E+00 | 2.00000E+00 | −7.60568E−01 | −1.18556E+02 | 4.19193E+00 | −5.92259E+00 |
| A | 1.80630E−04 | 3.84159E−05 | 3.48640E−03 | 3.58949E−03 | 2.71323E−03 | −2.05081E−02 |
| B | −1.95575E−04 | −2.29468E−04 | 6.63650E−04 | 3.47039E−03 | 2.75084E−03 | 6.20545E−03 |
| C | 2.99844E−05 | 4.43175E−05 | 4.49929E−05 | −6.95693E−04 | −1.90973E−03 | −2.04249E−03 |
| D | 0.87742E−08 | −3.74170E−07 | 2.23467E−05 | 2.80144E−04 | 5.84039E−04 | 3.52417E−04 |
| E | 0.00000E+00 | 0.00000E+00 | 0.00000E+00 | 0.00000E+00 | −8.22999E−05 | −3.13937E−05 |

Table 6 below presents distances for respective zoom positions of the asterisked parts among the items of Thickness (D) in Table 4.

TABLE 6

| Surface | Wide Angle End | | Telephoto End |
|---|---|---|---|
| No. | (W) | Middle End | (T) |
| 7 | 0.696 | 2.437 | 1.600 |
| 9 | 6.152 | 2.624 | 0.508 |
| 17 | 0.894 | 2.681 | 5.634 |

The inventive zoom lens optical systems having the constructions corresponding to the embodiments of FIGS. 1 and 2 satisfy Formulas 1 to 7, wherein the values of respective Formulas (Formula 1 through Formula 7) are presented in Table 7 below.

TABLE 7

| | Formula 1 | Formula 2 | Formula 3 | Formula 4 | Formula 5 | Formula 6 | Formula 7 |
|---|---|---|---|---|---|---|---|
| Embodiment | −2.40 | 36.89 | 10.17 | −2.83 | −7.71 | −0.10 | 0.48 |
| of FIG. 1 | | | | | | | |
| Embodiment | −2.76 | 29.98 | 8.71 | −2.58 | −17.95 | −0.12 | 0.58 |
| of FIG. 2 | | | | | | | |

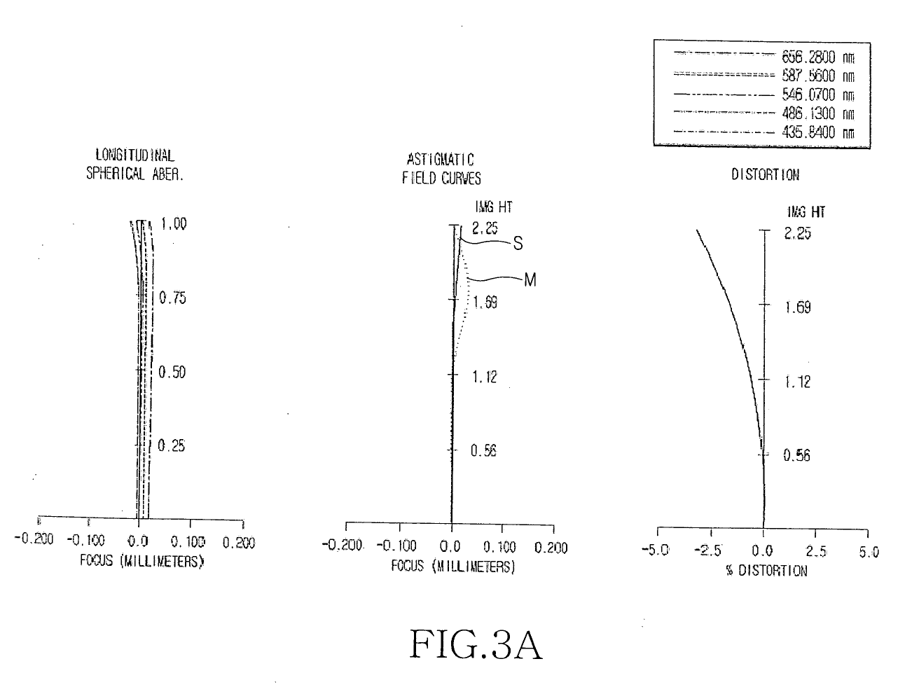

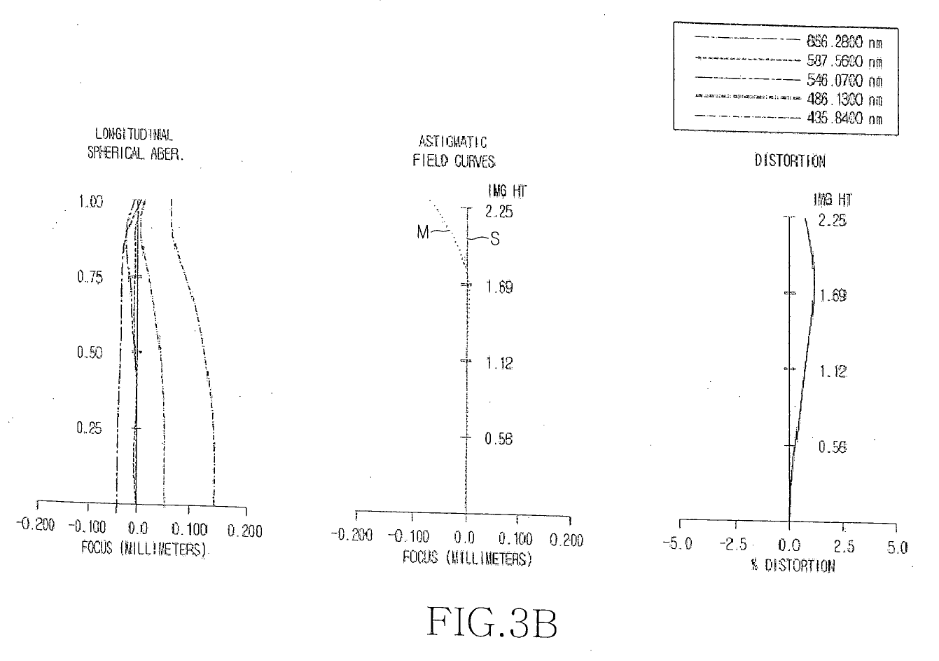

FIGS. 3A and 3B are wide angle end (W)/telephoto end (T) aberration graphs according to the first embodiment, to which the data of Tables 1 to 3 of the zoom lens optical system of FIG. 1 are applied. Astigmatic field curves M based on a meridional plane, astigmatic field curves S based on a sagital plane and distortion aberration curves are depicted with respect to a 546.0740 nm wavelength.

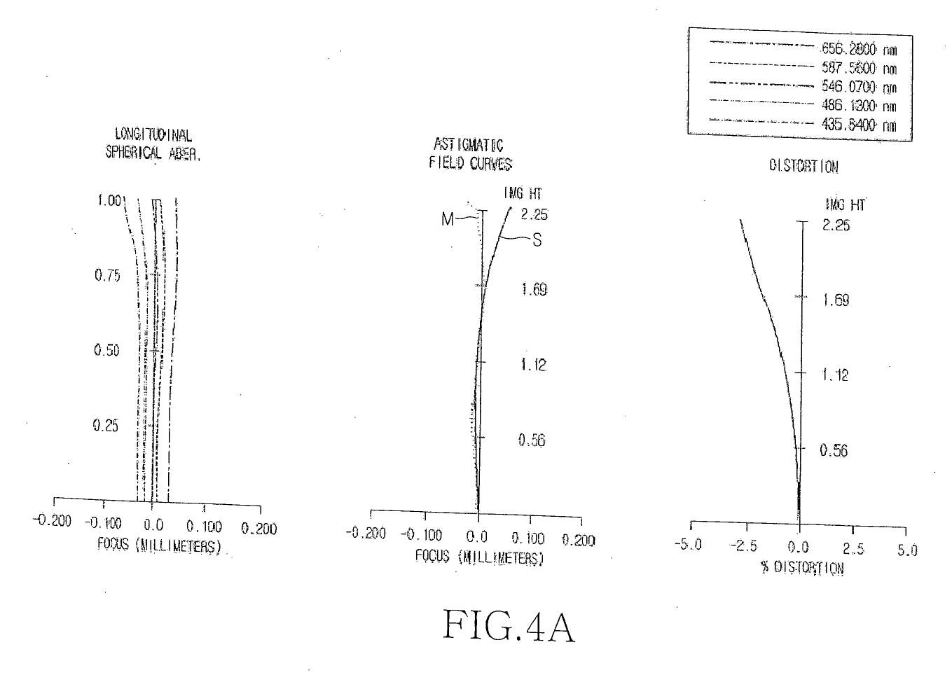

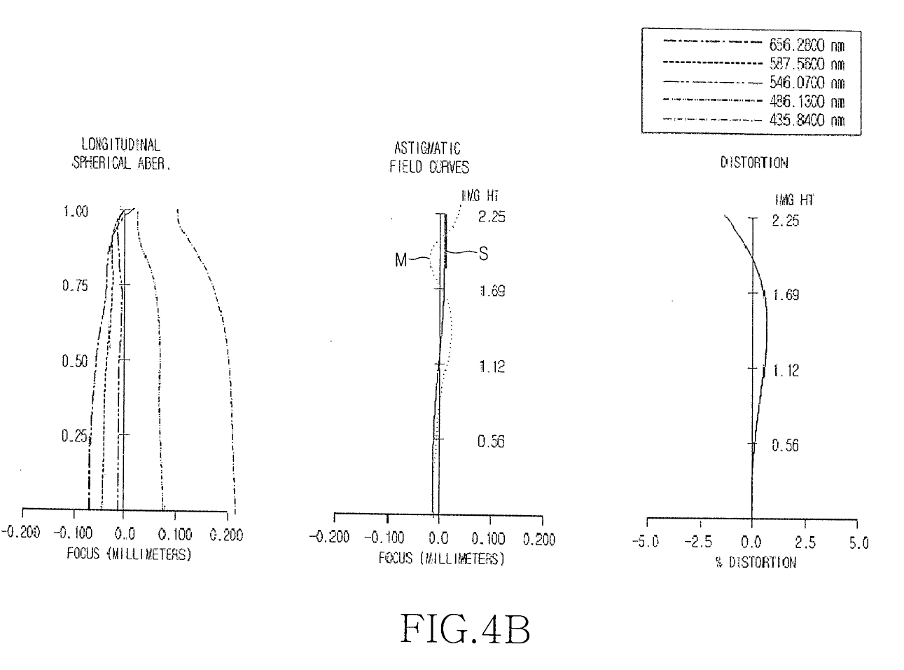

FIGS. 4A and 4B are wide angle end (W) telephoto end (T) aberration graphs according to the second embodiment, to which the data of Tables 4 to 6 of the zoom lens optical system of FIG. 2 are applied. Astigmatic field curves M based on a meridional plane, astigmatic field curves S based on a sagital plane and distortion aberration curves are depicted with respect to a 546.0740 nm wavelength.

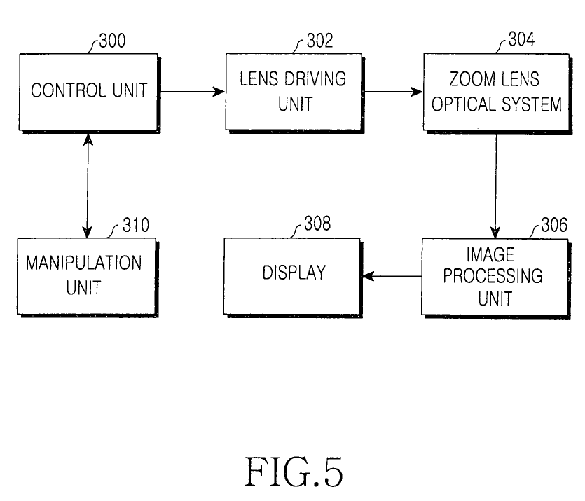

FIG. 5 is a block diagram illustrating a construction of an embodiment of a digital photographing device equipped with the inventive zoom lens optical system, wherein the digital photographing device includes the inventive zoom lens optical system 304, a lens driving unit 302, an image processing unit 306, a manipulation unit 310, and a control unit 300. The photographing device of FIG. 5 may further include a display unit 308.

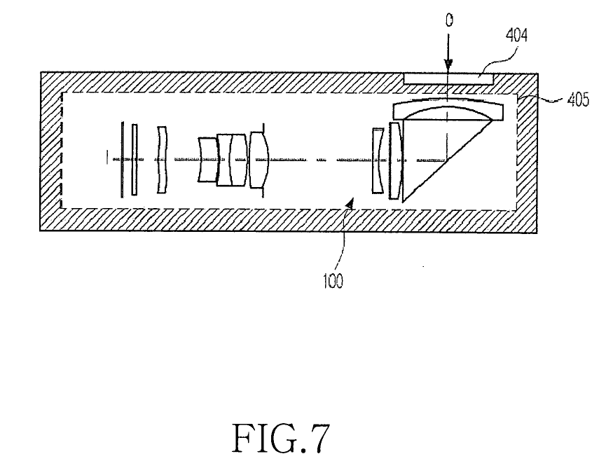

Firstly, as the zoom lens optical system 304, any of the inventive zoom lens optical systems described above with reference to FIGS. 1 and 2 is employed, wherein an example of mounting such a zoom lens optical system is illustrated in FIG. 7. The zoom lens optical system 304 executes photoelectric conversion of light incident from an object at an image sensor such as a CCD.

The lens driving unit 302 includes a driving source (a motor or the like) and a driving circuit thereof for moving lens groups (G2 and G3 of FIGS. 1 and 2), astop ST, and a focus lens G4 (or an image sensor) provided in the zoom lens optical system 304.

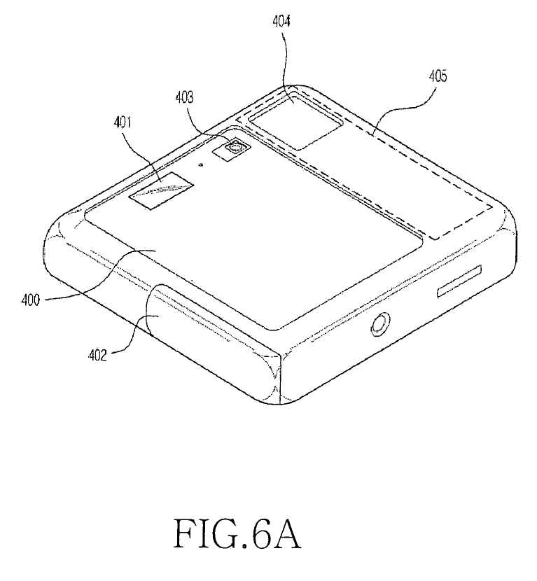

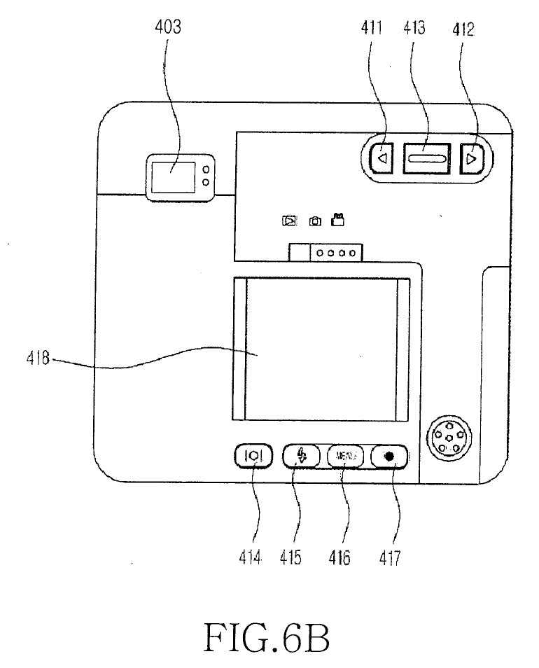

The manipulation unit 310 is manipulated by a user so as to generate a photographing command signal. As exemplified in FIG. 6B, the manipulation unit 310 may be provided with various menu setting buttons, a power button, a zoom button, or the like.

The control unit 300 controls the lens driving unit 302 according to the photographing command signal inputted through the manipulation unit 310, so that photographing is executed at a predetermined magnification.

The image processing unit 306 processes a photo-electrically converted signal inputted from the zoom lens optical system 304, thereby outputting a digital image. For this purpose, the image processing unit 306 includes a CDS (Correlated Double Sampling) circuit, an AGC (Auto Gain Control) circuit, and various signal correction circuits so as to suppress noise of such a photo-electrically converted signal, and executes image signal processing, such as profile correction, gamma correction, AWB (Auto White Balance) processing, etc., according to a product design specification. In addition, the image processing unit 306 converts the processed image into a predetermined storage type file, e.g., a JPEG (Joint Photographic Coding Experts Group) file. The image processing unit 306, which may include a memory capable of temporarily storing an image file, outputs the image file to an external storage device (not shown).

The display unit 308 serves to provide a screen for previewing an image to be photographed and to reproduce an image provided from the image processing unit 306, wherein the display unit 308 may be implemented by an LCD (Liquid Crystal Display) or the like.

FIG. 6A shows an example of a digital photographing device, within which the inventive zoom lens optical system is contained, wherein the digital photographing device includes a flash unit (401), a view finder (403), a lens cover (404), an inner space for the zoom lens optical system and a battery (402).

FIG. 6B shows a construction, which may be applied to the rear side of the digital photographing device, by way of an example, wherein the construction includes the viewfinder 403, a display 418, a plurality of manipulation buttons 414, 415, 416 and 417, direction buttons 411 and 412, a zoom button 413, etc. so that a user can perform manipulation and confirmation for executing photographing at a predetermined magnification.

Various kinds of the components 302, 304, 306 and 308 illustrated in FIG. 5 are housed within the digital camera as shown in FIGS. 6A and 6B as an internal circuit, a zoom lens optical device, and mechanical elements of the digital camera. Referring to FIG. 7, in a state in which a lens cover 404 is located at a lower position, a lens inlet is opened and the light incident from an external object O is incident into the CCD image sensor I through the zoom lens optical system 100.

As described above, according to the present invention, it is possible to provide a zoom lens capable of being well corrected in various aberrations while allowing a flexure type optical system in a form of an inner zoom to be miniaturized with a relatively simple construction. Accordingly, it is possible to manufacture a zoom lens optical system which can satisfy the requirements of stable design and easily miniaturized, and a digital photographing device having same.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A zoom lens optical system comprising:
a first lens group, which is fixed and has a total reflection prism, the prism turning an optical axis from an object side to an image side, and the first lens group having a positive lens power;
a second lens group having a negative lens power;
a third lens group having a positive lens power; and
a fourth lens group having a positive lens power,
wherein the first through fourth lens groups are sequentially arranged from the object side to the image side, and the fourth lens group is fixed while magnification variation is executed by moving the second lens group and the third lens group.

2. The zoom lens optical system according to claim 1, wherein auto-focusing according to the magnification variation is executed by moving the fourth lens group.

3. The zoom lens optical system according to claim 1, further comprising an image sensor at an image side final end passing the fourth lens group, auto-focusing according to the magnification variation being executed by moving the image sensor.

4. The zoom lens optical system according to claim 1, wherein the system satisfies the following formula:
$$- 25.0 > \frac{{f}_{G 1}}{{f}_{W}} > - 40.0$$
where f_{G1} is a focal length of the first lens group (G1), and f_{W} is an focal length of a wide angle end.

5. The zoom lens optical system according to claim 4, wherein the first lens group G1 comprises a first lens L1, a second lens L2 which is a total reflection prism, and a third lens L3, the first through third lens being sequentially arranged from the object side to the image side.

6. The zoom lens optical system according to claim 5, wherein the system satisfies the following formulas:
$$- 2.0 > \frac{{f}_{L 1}}{{f}_{L 3}} > - 3.0 , and \\ - 7.0 > \frac{{f}_{G 1}}{{f}_{L 3}} > - 12.0$$
where f_{L1} is a focal length of the first lens L1, and f_{W} is a focal length of the wide angle end, f_{G1} is a focal length of the first lens group G1, and f_{L3} is a focal length of the third lens L3.

7. The zoom lens optical system according to claim 4, wherein the second lens group comprise a single fourth lens L4.

8. The zoom lens optical system according to claim 7, wherein the system satisfies the following formulas:
$$- 2.0 > \frac{{f}_{G 2}}{{f}_{W}} > - 3.0 , and \\ - 5.0 > \frac{R {2}_{L 4}}{R {1}_{L 4}} > - 20.0$$
where f_{G2} is a focal length of the second lens group G2, and f_{W} is a focal length of the wide angle end, R2_{L4} is a radius of curvature of the fourth lens L4 focal length of the first lens group G1, and f_{L3} is a focal length of the third lens L3.

9. The zoom lens optical system according to claim 6, wherein the system satisfies the following formula:
$$- 0.08 > \frac{{M}_{G 3}}{{X}_{G 3}} > - 0.13$$
where M_{G3} is a magnification of the third lens group G3, and X_{G3} is an amount of movement of the third lens group G3 at the time of magnification variation.

10. The zoom lens optical system according to claim 6, wherein the system satisfies the following formula:
$$0.60 > \frac{{f}_{T}}{{f}_{W} {X}_{G 3}} > 0.45$$
where f_{T} is a focal length of a telephoto end, f_{w} is a focal length of the wide angle end, and X_{G3} is an amount of movement of the third lens group G3 at the time of magnification variation.

11. A digital photographing device comprising:
a zoom lens optical system comprising:
a first lens group, which is fixed and has a total reflection prism, the prism turning an optical axis from an object side to an image side, and the first lens group having a positive lens power;
a second lens group having a negative lens power;
a third lens group having a positive lens power; and
a fourth lens group having a positive lens power, wherein the first through fourth lens groups are sequentially arranged from the object side to the image side, and the fourth lens group is fixed wherein magnification variation is executed by moving the second lens group and the third lens group;
a driving unit for the movable lens groups of the zoom lens optical system;
an image processing unit for processing a signal inputted from the zoom lens optical system, thereby outputting a digital image;
a manipulation unit manipulated by a user so as to generate a photographing command signal; and
a control unit for controlling the driving unit according to the photographing command signal, so that photographing is executed at a predetermined magnification.

12. A digital photographing device comprising:
a zoom lens optical system comprising:
a plurality of lens groups including a first lens group, a second lens group having a negative lens power; a third lens group having a positive lens power; and a fourth lens group having a positive lens power, wherein the first through fourth lens groups are sequentially arranged from an object side to an image side, and the first and fourth lens group are fixed and a magnification variation is executed by moving the second lens group and the third lens group;
means for driving said second and third lens group;
means for processing a signal inputted from the zoom lens optical system, thereby outputting a digital image;
means for providing a command signal; and
a control unit for controlling the driving means according to the command signal, so that photographing is executed at a predetermined magnification.

13. The device according to claim 12, wherein said first lens group comprises:
first and second lenses; and
a prism positioned between the first and second lenses.

14. The device according to claim 13, wherein said first lens has a negative refracting power and the surface of the second lens facing the first lens is aspherical.

15. The device according to claim 12, wherein said second lens group comprises:
a lens having a negative refracting power.

16. The device according to claim 12, wherein said third lens group comprises:
two aspherical lenses, and
a combination lens positioned between the two aspherical lenses,
wherein both surfaces of the combination lens are spherical.

17. The device according to claim 12, wherein said fourth lens group comprises:
an aspherical lens.

18. The device according to claim 12, wherein movement of said second lens group is curvilinear and movement of said third lens group is linear.

19. The device according to claim 18, wherein said third lens group moves toward the object side.

20. The device according to claim 12, further comprising:
a filter.
